(19) United States
(12) Patent Application Publication
(10) Pub. No.: US 2005/0125265 A1
(43) Pub. Date: Jun. 9, 2005

(54) System and method to re-accommodate airline passengers on an individualized basis via a self-service device

(75) Inventors: Arnold H. Bramnick, Boca Raton, FL (US); J. Kendall Burch, Cooper City, FL (US); Lee E. Farnum, Fairfield, CT (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/730,851

(22) Filed: Dec. 9, 2003

(51) Int. Cl. G06F 17/60

(52) U.S. Cl. 705/5

(57) ABSTRACT

A method for rebooking a passenger who is unable to travel on a scheduled flight is described. The method can include obtaining passenger data for the passenger, comparing the passenger data with one or more rules, and presenting rebooking flight candidates to the passenger based upon the comparing step.

### BACKGROUND

1. Field of the Invention

This invention relates generally to the commercial airline industry and, more particularly, to systems and methods to reaccommodate airline passengers who are unable to travel on scheduled flights.

2. Background of the Invention

Airline passengers who are unable to travel on flights or scheduled connections must be rebooked on other flights. Such passengers are sometimes rebooked automatically, but often the passenger must wait in line to talk to a customer service representative (CSR) and receive a new flight schedule. Passengers are usually rebooked based only on the availability of seats on other flights, whether the flights are on the original airline or an alternative airline. Kiosks and self-service stations have recently been implemented at airports and over the Internet, however, the self-service booking and rebooking process is again typically based only on the availability of seating.

### SUMMARY OF THE INVENTION

A method for rebooking passengers who are unable to travel on scheduled flights can include obtaining passenger data for the passenger, comparing the passenger data with one or more rules, and presenting rebooking flight candidates to the passenger based upon the comparing step.

Rebooking flight candidates are presented to the passenger based upon the passenger data. Passenger value can be determined from the passenger data based upon the rules. Rebooking flight candidates can be offered to the passenger based upon the passenger value. The passenger data is provided in substantially real time.

In another embodiment, passenger data of the passenger can be compared to passenger data of at least one other passenger in need of rebooking. Each passenger can be offered rebooking flight candidates based upon the comparing step.

The presenting step can present flight rebooking candidates which have a high remaining unflown value to the airline and not present rebooking candidates with lower unflown values. The presenting step can offer the passenger incentives for selecting rebooking flight candidates with high remaining unflown value to the airline.

The passenger data can include the frequent flyer status of the passenger. The remaining unflown ticket value can be considered. The rebooking cost for each passenger can be considered, such as payments that may be required to another airline and the cost of meal and hotel reimbursements. The lifetime value for each passenger can be included in the passenger data. The passenger data can specify whether another flight on the same airline is available, or whether the passenger must be re-accommodated on a competitor airline.

A system for rebooking passengers who are unable to travel on scheduled flights can include a data store specifying passenger data and flight operations data. The flight operations data can include rebooking flight candidates for the passenger. Means are provided for presenting to the passenger rebooking flight candidates based upon the passenger data. The means for presenting can include any suitable device, including PDAs, kiosks, laptop computers, web enabled mobile phones, voice response units, and any other suitable means by which passengers are able to make travel selections. Means can also be provided for comparing the flight operations data for the rebooking flight candidates. Notably, the rebooking flight candidates can be ranked using rules.

Other embodiments of the present invention can include a system having means for performing the various steps disclosed herein as well as a machine readable storage for causing a machine to perform the steps described herein.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram of a system for rebooking passengers according to one embodiment of the invention.

FIG. 2 is a representation of a screen shot according to another embodiment of the invention.

FIG. 3 is a representation of a screen shot according to another embodiment of the invention.

FIG. 4 is a representation of a screen shot in accordance with yet another embodiment of the invention.

FIG. 5 is a flow diagram illustrating a method according to another embodiment of the invention.

### DETAILED DESCRIPTION OF THE INVENTION

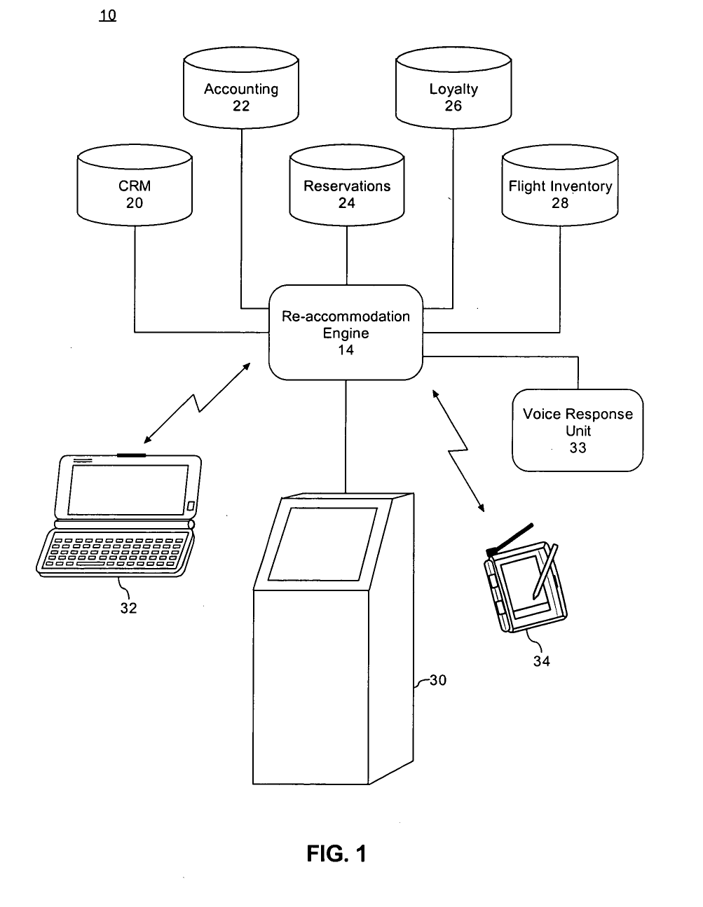

There is shown in FIG. 1 a system 10 according to one embodiment of the invention. The system 10 includes a re-accommodation engine 14 with access to various types of data 20-28. A number of different clients 30-34 can be provided through which passengers can access the system 10 to select rebooking candidates.

The data accessed by the re-accommodation engine 14 can be suitable passenger data. As shown, and without limitation, the passenger data can include Customer Relationship Management (CRM) data 20, accounting data 22, and loyalty data 26. The CRM data 20 can include any suitable information relating to passengers. For example, the CRM data 20 can include data pertaining to past transactions between the carrier and individual passengers as well as feedback provided from individual passengers. The accounting data 22 can include information relating to the value of passenger tickets. The ticket value information can be specified on a per leg basis for each issued ticket or passenger. That is, the individual segments of a given flight itinerary can be valued individually. Loyalty data 26 can include any information traditionally tracked by a frequent flyer club or organization.

Flight operations data can also be accessed by the re-accommodation engine 14. The flight operations data can include reservations data 24 and flight inventory data 28. The reservations data 24 can specify which passengers have been booked on particular flights, the seating assignment for each passenger, as well as a class of service. Flight inventory data 28 can specify which flights are available as alternatives for other flights and the values of such flights. In any case, it should be appreciated that additional data sources also can be used.

Each of the various types of data can be included within a suitable data store. The re-accommodation engine 14 can access each of the various data stores through a suitable communications link such as a communications network. While each data type is depicted as being located within a separate data store, it should be appreciated that one or more of the various data types can be included within a same data store.

The re-accommodation engine 14 can be implemented as a computer program executing within a suitable information processing system such as a computer system or a server. As such the re-accommodation engine 14 can be programmed to perform one or more of the functions described herein. The re-accommodation engine 14 can be programmed with one or more rules for selecting among passengers according to passenger data and selecting rebooking candidates according to flight operations data.

In one aspect, the rules can require the selection of passengers according to the descending revenue impact on the airline. In another aspect, the rules can require selection based on the lifetime value of the passenger, which can be a valuation based upon factors such as frequent flyer status and/or average value of past ticket purchases. In another aspect, the rules can weigh or value various passenger data according to the preferences of the airline and select those passengers with the most favorable scores or the highest value. Each of the aforementioned attributes, and combinations thereof, can be considered. Further, it should be appreciated that the rules can specify how raw data can be processed to determine one or more of the aforementioned valuation metrics if such information is not directly available from one of the data stores.

The rules further can account for other considerations such as whether the flight rebooking candidate is on another airline for which a fee must be paid by the original airline. Also, the class of ticket that is available on rebooking flight candidates can be considered. Other considerations are possible as well including, but not limited to the value of the rebooking flight candidates.

In one aspect, the rules can provide that only the most preferential rebooking flight candidate is presented. In other aspect, a limited number of the most preferred rebooking flight candidates can be presented. In still another aspect, all or several rebooking candidates can be presented, however, various incentives such as discounts, upgrades, and the like can be provided to encourage the passenger to select rebooking flight candidates that are preferred according to the rules.

The information that is generated by the re-accommodation engine 14 can be provided to the passenger through any suitable communications device. For example, stations such as kiosks 30 are becoming common in airports and other locations to permit passengers to schedule or modify travel plans without the assistance of an airline employee. It is also known that such information can be accessed through devices such as personal computers 32 including laptop computers and personal digital assistants 34 having direct connect or wireless capability, as well as any other devices capable of communicating with the information processing system within which the re-accommodation engine 14 is disposed and through which passengers can make travel selections.

Information generated by the re-accommodation engine 14 also can be provided to passengers through a voice response unit (VRU) 33. For example, callers can place telephone calls to the VRU 33 and request information. The VRU 33 can include a text-to-speech system and a speech recognition and/or dual tone multi-frequency recognizer through which the caller can interact with the VRU over the telephone call.

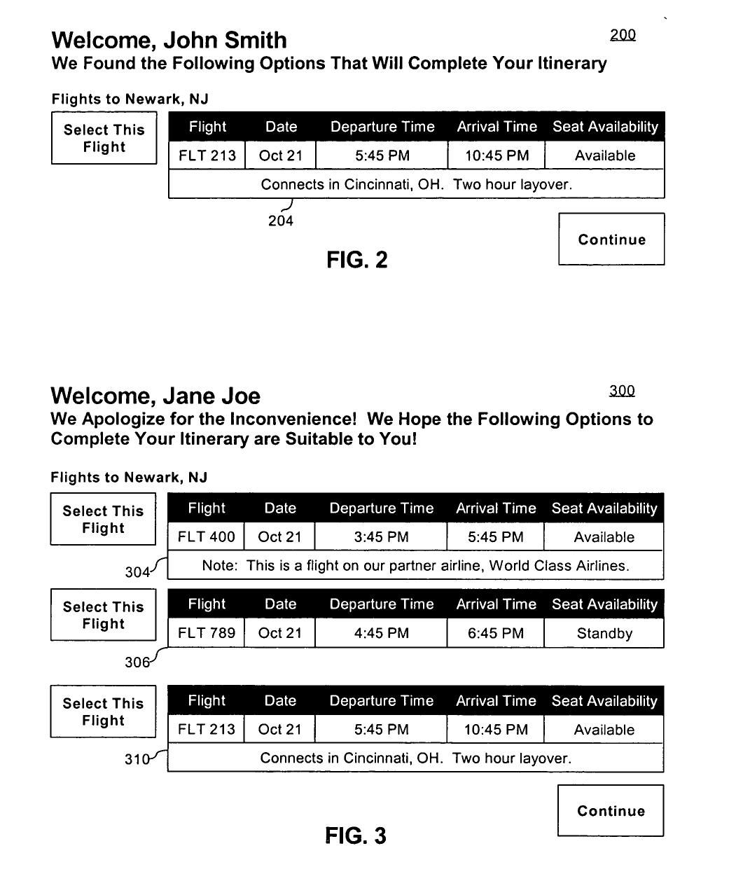

The manner of presentation to the passenger can vary. FIGS. 2-4 show representative screen shots which present selections to the passenger. In screen shot 200, a selection 204 is provided of the most preferred rebooking flight candidate as determined and provided by the information processing system. In FIG. 3, a screen shot 300 provides more selections 304-310 due to the fact that the passenger has been determined to be a more valued customer according to the rules, and is therefore provided with more rebooking flight candidate options. The value of the customer can be determined by suitable criteria such as frequent flyer status, class of ticket, the value of tickets purchased by the passenger with the carrier over a particular period of time, or other considerations.

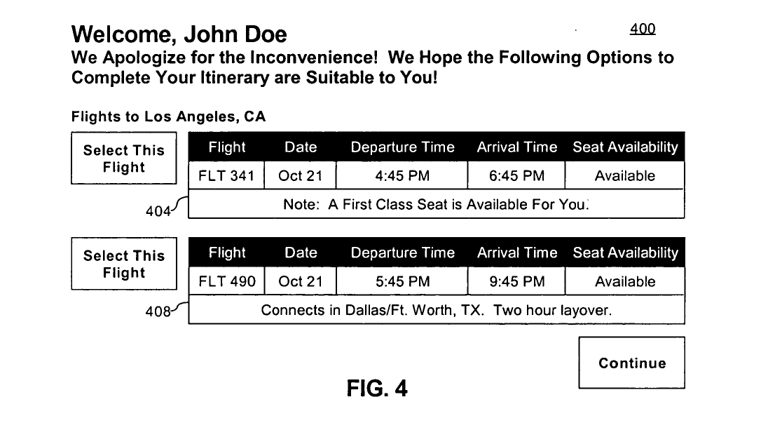

In FIG. 4, a screen shot 400 presents two flight rebooking candidates 404 and 408. The flight rebooking candidate 404 that is most preferred by the airline provides the passenger with an incentive such as a first class upgrade. The incentive encourages the passenger to select this flight rebooking candidate over candidate 408.

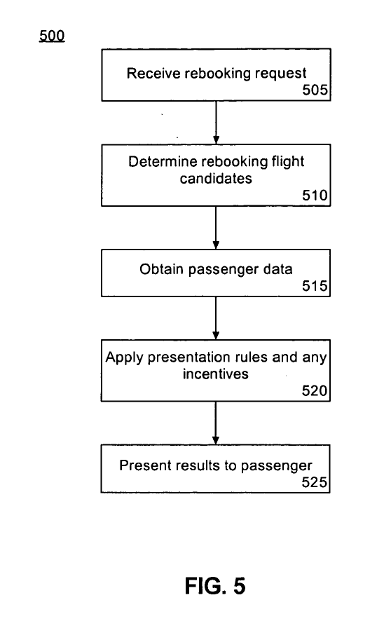

A method according to another embodiment of the invention is shown in FIG. 5. According to the method 500, a rebooking request is received from a passenger in step 505. Rebooking flight candidates are determined in step 510. Passenger data is obtained for the passenger in step 515. Presentation rules and any incentives are applied to the passenger data in step 520. The results are presented to the passenger in step 525. The passenger then can be matched with any rebooking candidates. That is, the passenger can be matched with rebooking flight candidates based upon a valuation of the passenger and a valuation of the rebooking flight candidates as set forth by the airline rules.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which includes all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method for rebooking a passenger who is unable to travel on a scheduled flight, comprising the steps of:
obtaining passenger data for said passenger;
comparing the passenger data with one or more rules; and
presenting rebooking flight candidates to said passenger based upon said comparing step.

2. The method of claim 1, wherein a passenger value is determined from the passenger data by the application of the rules, and said rebooking flight candidates are offered to said passenger based upon said passenger value.

3. The method of claim 1, wherein said passenger data of said passenger is compared to passenger data of at least one other passenger in need of rebooking, and said passenger is offered rebooking flight candidates based upon said comparing step.

4. The method of claim 1, wherein said passenger data is provided in substantially real time.

5. The method of claim 1, wherein said presenting step comprises presenting high remaining unflown value flight rebooking candidates and not presenting rebooking flight candidates with lower unflown values.

6. The method of claim 1, wherein said presenting step comprises offering said passenger incentives for selecting rebooking flight candidates with high remaining unflown value.

7. The method of claim 1, wherein said passenger data comprises the remaining unflown ticket value for said passenger.

8. The method of claim 1, wherein said passenger data comprises passenger loyalty data.

9. A system for rebooking passengers who are unable to travel on scheduled flights, comprising:
a data store comprising passenger data and flight operations data, said flight operations data comprising flight rebooking candidates for said passenger; and
means for presenting to said passenger rebooking flight candidates based upon said passenger data.

10. The system of claim 9, further comprising means for comparing said flight operations data for said rebooking flight candidates.

11. The system of claim 9, wherein said means for comparing ranks said rebooking flight candidates according to rules.

12. The system of claim 9, wherein said means for presenting rebooking candidates to said passenger comprise a kiosk.

13. A machine readable storage, having stored thereon a computer program having a plurality of code sections executable by a machine for causing the machine to perform the steps of:
obtaining passenger data for a passenger; and
comparing the passenger data with one or more rules; and
presenting rebooking flight candidates to said passenger based upon said comparing step.

14. The machine readable storage of claim 13, wherein a passenger value is determined from the passenger data by the application of the rules, and said rebooking flight candidates are offered to said passenger based upon said passenger value.

15. The machine readable storage of claim 13, wherein said passenger data of said passenger is compared to passenger data of at least one other passenger in need of rebooking, and said passenger is offered rebooking flight candidates based upon said comparing step.

16. The machine readable storage of claim 13, wherein said passenger data is provided in substantially real time.

17. The machine readable storage of claim 13, wherein said presenting step comprises presenting high remaining unflown value flight rebooking candidates and not presenting rebooking flight candidates with lower unflown values.

18. The machine readable storage of claim 13, wherein said presenting step comprises offering said passenger incentives for selecting rebooking flight candidates with high remaining unflown value.

19. The machine readable storage of claim 13, wherein said passenger data comprises the remaining unflown ticket value for said passenger.

20. The machine readable storage of claim 1, wherein said passenger data comprises passenger loyalty data.

21. The machine readable storage of claim 13, wherein said comparing step compares passenger data with flight operations data for said rebooking flight candidates.

22. The method of claim 1, wherein said comparing step compares passenger data with flight operations data for said rebooking flight candidates.

23. A system for rebooking a passenger who is unable to travel on a scheduled flight, comprising:
means for obtaining passenger data for said passenger;
means for comparing the passenger data with one or more rules; and
means for presenting rebooking flight candidates to said passenger based upon said comparing step.
